(19) United States
(12) Patent Application Publication
(10) Pub. No.: US 2012/0126644 A1
(43) Pub. Date: May 24, 2012

(54) WATERPROOF AND DUSTPROOF MOTOR HEAT DISSIPATION STRUCTURE AND FAN DEVICE USING THE SAME

(76) Inventor: Bill Wu, Sinjhuang City (TW)

(21) Appl. No.: 12/953,911

(22) Filed: Nov. 24, 2010

(51) Int. Cl. H02K 9/22; F01D 1/02; H02K 5/18

(52) U.S. Cl. 310/64; 415/198.1

(57) ABSTRACT

A fan device includes a housing, a fan wheel assembly, a stator and an enclosure unit. The fan wheel assembly is located within the housing and includes a rotor and a plurality of blades. The stator is connected to a circuit board, and the enclosure unit encloses the stator and the circuit board therein, and is located within the housing. The enclosure unit has at least an extension portion located corresponding to the blades. Heat produced by the stator and the circuit board is transferred to the extension portion and then carried away therefrom by airflow that is sucked into the housing by the blades and blown to the extension portion, so as to cool the extension portion and produce a heat dissipation effect to the stator and the enclosure unit.

### FIELD OF THE INVENTION

The present invention relates to a waterproof and dustproof motor heat dissipation structure and fan device using the same, and more particularly to a motor heat dissipation structure and fan device using the same, with which airflow sucked into the fan device by blades thereof are blown to an enclosure unit that encloses a stator of the motor therein.

### BACKGROUND OF THE INVENTION

A fan device is one of the best choices for forcefully carrying away heat produced by a heat-producing element in an electronic device, and has very good heat dissipation effect. The fan device usually includes a frame, a stator, and a rotor. The stator and the rotor are mounted in the frame. The stator includes coils, silicon steel plates and a support, and is connected to a circuit board. When the stator and the rotor are excited, the rotor is brought to rotate. In the conventional fan device, the stator and the circuit board are exposed to ambient air, and are therefore subject to damage and failure caused by the moisture and dust in the ambient air that tend to attach to or deposit on the stator and the circuit board.

To overcome the problem of damaged stator and circuit board caused by moisture and dust, the stator is coated with a protective layer and accordingly isolated from air, so as to achieve the purpose of guarding the fan motor against water and dust. However, the following problems are found with the conventional stator coated with the protective layer: heat produced by the stator is completely sealed inside the protective layer and could not be dissipated into external environment, resulting in an overheated stator, which might stop operating or even become damaged.

It is therefore tried by the inventor to develop an improved waterproof and dustproof motor heat dissipation structure and fan device using the same, in order to overcome the problem existed in the conventional fan motor structure.

### SUMMARY OF THE INVENTION

A primary object of the present invention is to provide a waterproof and dustproof motor heat dissipation structure, which includes an enclosure unit for enclosing a stator and a circuit board of the motor therein, and the enclosure unit having an extension portion located corresponding to blades of a fan device using the motor, so that airflow sucked into the fan device by the blades are blown to the extension portion to thereby carry away heat produced by the stator and transferred to the enclosure unit.

Another object of the present invention is to provide the above-described waterproof and dustproof motor heat dissipation structure, in which the extension portion corresponding to the blades includes a plurality of radially outward protruded sections spaced along an outer peripheral edge of the enclosure unit, so that a recess is formed between any two adjacent protruded sections of the extension portion, allowing the enclosure unit to have an increased contact area with the airflow. Thus, the heat dissipation ability of the enclosure unit is upgraded to provide enhanced cooling effect to the stator and the circuit board.

To achieve the above and other objects, the waterproof and dustproof motor heat dissipation structure according to an operable embodiment of the present invention includes a stator located on a base and connected to a circuit board; and an enclosure unit having a first portion, a second portion, and an extension portion. The first portion encloses the stator therein, the second portion encloses the circuit board therein, and the extension portion is radially outward extended from the second portion to correspond to at least one blade of a fan device.

To achieve the above and other objects, the present invention also provides a fan device using the above-described motor heat dissipation structure. The fan device includes a housing having a base, a first opening, and a second opening opposite to the first opening, and the base being located within the second opening at a central area of the housing; a fan wheel assembly being located within the housing and including a hub, a plurality of blades and a rotor, the blades being located corresponding to the first opening and the second opening, and the rotor being attached to an inner wall surface of the hub; a stator being located on the base and connected to a circuit board and located corresponding to the rotor; and an enclosure unit having a first portion, a second portion, and an extension portion, the first portion enclosing the stator therein, the second portion enclosing the circuit board therein, and the extension portion being radially outward extended from the second portion and located corresponding to the blades.

In an embodiment of the present invention, the extension portion is continuously located around a peripheral edge of the second portion. In another embodiment of the present invention, the extension portion includes a plurality of radially outward protruded curved sections spaced along the peripheral edge of the second portion, such that a recess is formed between any two adjacent ones of the outward protruded curved sections of the extension portion. The first portion and the second portion can be integrally formed or be separately formed and then coupled to each other.

The base includes a bearing cup portion and a plurality of connecting arm portions. The bearing cup portion is extended from a center of the base toward the first opening, and the connecting arm portions are spaced along an outer peripheral edge of the base to radially extend toward and connect to an inner wall surface of the housing. The fan wheel assembly further includes a shaft that has an end connected to an inner top surface of the hub and another opposite end inserted into the bearing cup portion.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a vertical sectional view of a waterproof and dustproof motor heat dissipation structure according to a preferred embodiment of the present invention showing a stator and an enclosure unit thereof;

FIG. 2 is an exploded vertical sectional view of a fan device according to the present invention;

FIG. 3 is an assembled view of FIG. 2;

FIG. 4A is a top plan view of a first embodiment of the enclosure unit for the waterproof and dustproof motor heat dissipation structure of the present invention;

FIG. 4B is a top plan view of a second embodiment of the enclosure unit for the waterproof and dustproof motor heat dissipation structure of the present invention; and

FIG. 4C is a top plan view of a third embodiment of the enclosure unit for the waterproof and dustproof motor heat dissipation structure of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

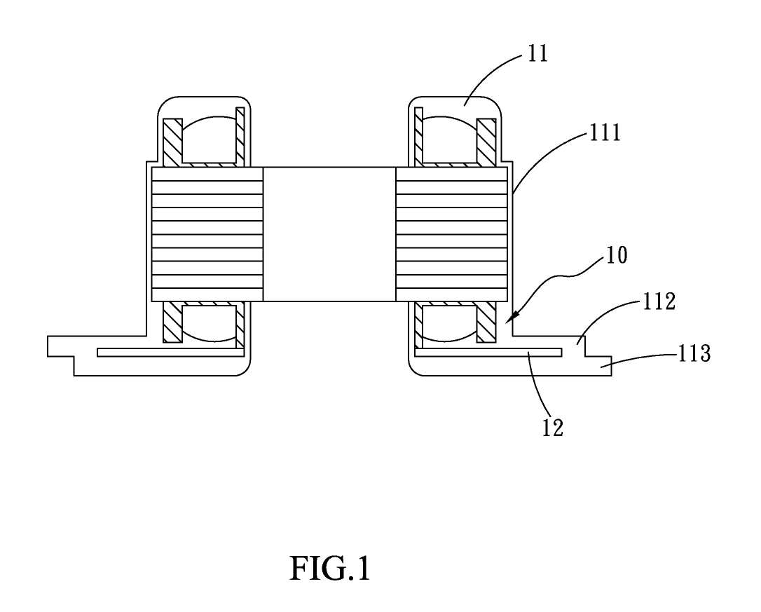

FIGS. 1 to 4 show a waterproof and dustproof motor heat dissipation structure and a fan device using same according to a preferred embodiment of the present invention. Please refer to FIG. 1 that is a vertical sectional view of the waterproof and dustproof motor heat dissipation structure according to the preferred embodiment of the present invention, which will also be briefly referred to as “the motor heat dissipation structure” herein. As shown, the motor heat dissipation structure includes a stator 10 and an enclosure unit 11. The stator 10 is connected at one side to a circuit board 12, and the enclosure unit 11 encloses the stator 10 and the circuit board 12 therein.

The enclosure unit 11 includes a first portion 111, a second portion 112, and an extension portion 113. The first portion 111 encloses the stator 10 therein, the second portion 112 encloses the circuit board 12 therein, and the extension portion 113 is radially outward extended from the second portion 112.

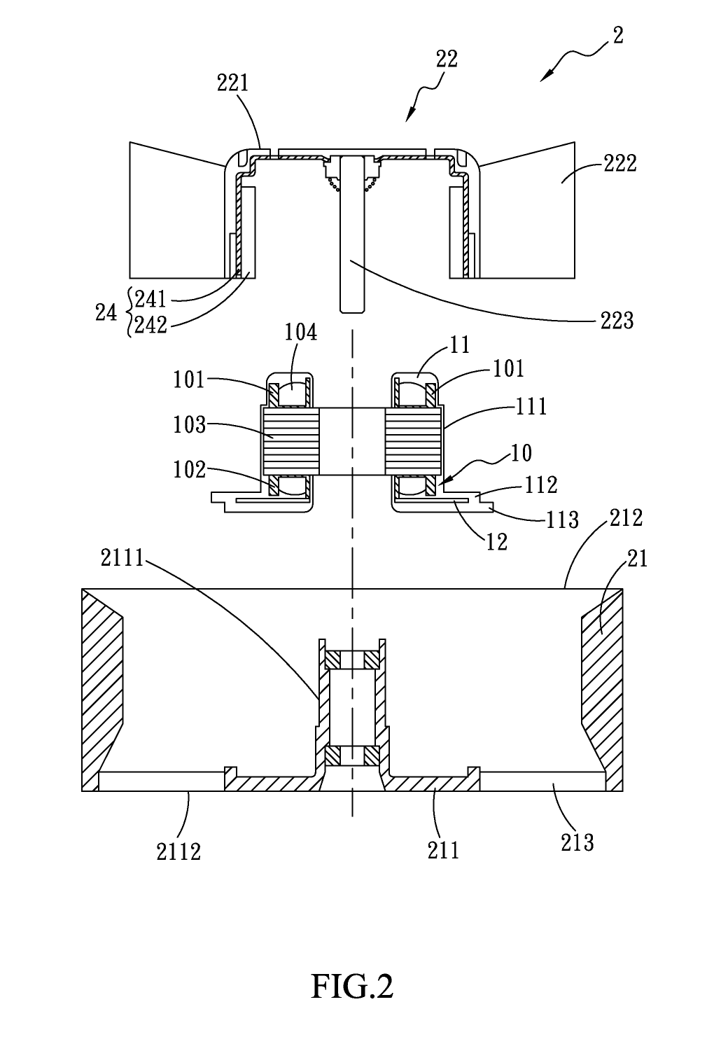

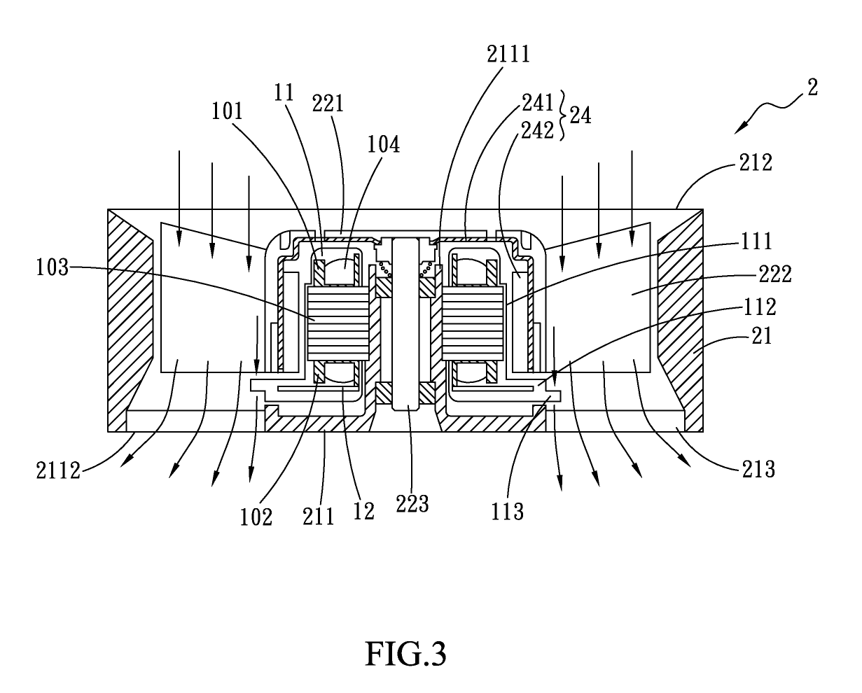

Please refer to FIGS. 2 and 3 that are exploded and assembled vertical sectional views, respectively, showing the fan device 2 of the present invention with the motor heat dissipation structure of FIG. 1 assembled thereto. As shown, the fan device 2 includes a housing 21, a fan wheel assembly 22, and the above-described stator 10 and enclosure unit 11. The fan wheel assembly 22, the stator 10, and the enclosure unit 11 are enclosed in the housing 21. The housing 21 includes a base 211, a first opening 212, and a second opening 213 opposite to the first opening 212. The base 211 is located within the second opening 213 and at a central area of the housing 21.

The base 211 includes a bearing cup portion 2111 and a plurality of connecting arm portions 2112. The bearing cup portion 2111 is extended from a center of the base 211 toward the first opening 212. The connecting arm portions 2112 are spaced along an outer peripheral edge of the base 211 to radially extend toward and connect to an inner wall surface of the housing 21 for supporting the base 211 in the center of the housing 21.

The fan wheel assembly 22 includes hub 221 and a plurality of blades 222. A shaft 223 and a rotor 24 are provided within the hub 221. The shaft 223 has an end connected to an inner top surface of the hub 221, and another opposite end inserted into the bearing cup portion 2111, such that the fan wheel assembly 22 is rotatably connected to and located in the housing 21. The rotor 24 includes an iron shell 241 attached to an inner wall surface of the hub 221, and a magnetic ring 242 mounted to an inner side of the iron shell 241 to face toward the stator 10.

The stator 10 and the circuit board 12 are externally fitted around the bearing cup portion 2111 to locate on the base 211 and face toward the magnetic ring 242. The stator 10 includes a support assembly formed from an upper support 101 and a lower support 102; a silicon steel plate assembly 103 formed from a plurality of laminated silicon steel plates and mounted on between the upper support 101 and the lower support 102 to correspond to the rotor 24; and a winding 104 wound around the upper support 101, the lower support 102 and the silicon steel plate assembly 103, and connected to the circuit board 12.

The second portion 112 of enclosure unit 11 corresponds to a rear edge of the hub 221, and the extension portion 113 radially outward extended from the second portion 112 corresponds to the blades 222. When the fan wheel assembly 22 is driven to rotate, the blades 222 suck airflow to flow from the first opening 212 toward the second opening 213. At this point, part of the airflow is blown to the extension portion 113 and then flows through the second opening 213 to an external environment outside the housing 21.

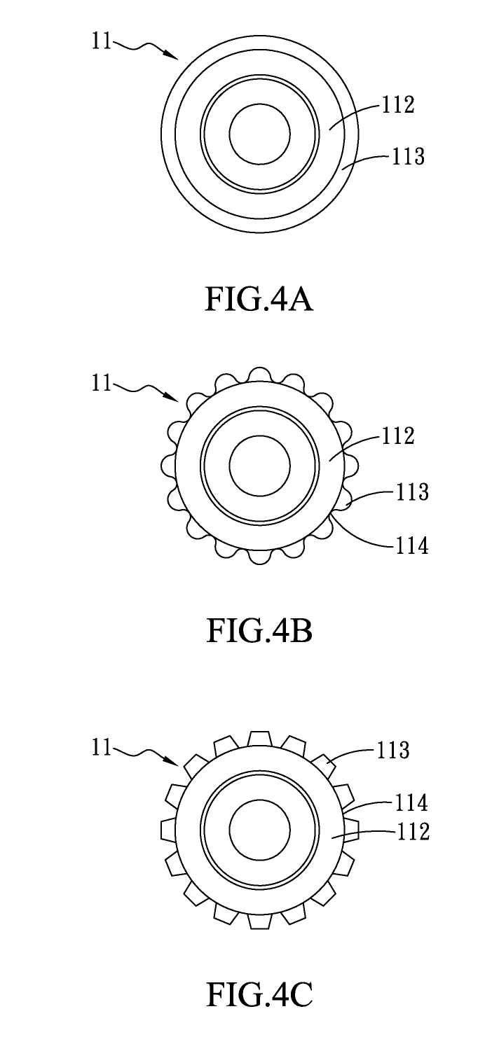

Please refer to FIGS. 4A, 4B and 4C. The extension portion 113 can be differently configured. FIG. 4A is a top view of the enclosure unit 11 showing the extension portion 113 is continuously located around a peripheral edge of the second portion 112. FIG. 4B is another top view of the enclosure unit 11 showing the extension portion 113 includes a plurality of radially outward protruded curved sections spaced along the peripheral edge of the second portion 112, such that a recess 114 is formed between any two adjacent ones of the outward protruded curved sections. In FIG. 4B, the recess 114 has a shape radially reverse to that of the curved sections of the extension portion 113. And, FIG. 4C is a further top view of the enclosure unit 11 showing the extension portion 113 includes a plurality of radially outward protruded gear tooth-like sections spaced along the peripheral edge of the second portion 112, such that a recess 114 is formed between any two adjacent ones of the outward protruded gear tooth-like sections.

The present invention has the following advantages compared to the prior art motor heat dissipation structure:

(1) The enclosure unit 11 includes an extension portion 113 corresponding to the blades 222; and the rotating blades 222 suck in and further blow the airflow against the extension portion 113 to carry away heat from the enclosure unit 11. Therefore, the problem of failing to transfer accumulated heat in the protective layer to the ambient air as found in the prior art can be now improved; and

(2) In the case the extension portion 113 includes a plurality of outward protruded sections spaced along the second portion 112 with a recess 114 formed between any two adjacent ones of the protruded sections, the enclosure unit 11 can provide an increased contact area with the airflow to thereby upgrade the heat dissipation ability of the enclosure unit 11 and provide enhanced cooling effect to the stator 10 and the circuit board 12.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A waterproof and dustproof motor heat dissipation structure, comprising a stator being located on a base and connected to a circuit board; and an enclosure unit having a first portion, a second portion, and an extension portion; wherein the first portion encloses the stator therein, the second portion encloses the circuit board therein, and the extension portion is radially outward extended from the second portion to correspond to at least one blade.

2. The waterproof and dustproof motor heat dissipation structure as claimed in claim 1, wherein the extension portion is continuously located around a peripheral edge of the second portion.

3. The waterproof and dustproof motor heat dissipation structure as claimed in claim 1, wherein the extension portion includes a plurality of radially outward protruded sections spaced along a peripheral edge of the second portion, such that a recess is formed between any two adjacent ones of the outward protruded sections of the extension portion.

4. A fan device, comprising:
a housing having a base, a first opening, and a second opening opposite to the first opening; and the base being located within the second opening at a central area of the housing;
a fan wheel assembly being located within the housing and including a hub, a plurality of blades and a rotor; the blades being located corresponding to the first opening and the second opening, and the rotor being attached to an inner wall surface of the hub;
a stator being located on the base and connected to a circuit board, and located corresponding to the rotor; and
an enclosure unit having a first portion, a second portion, and an extension portion; the first portion enclosing the stator therein, the second portion enclosing the circuit board therein, and the extension portion being radially outward extended from the second portion to correspond to the blades.

5. The fan device as claimed in claim 4, wherein the extension portion is continuously located around a peripheral edge of the second portion.

6. The fan device as claimed in claim 4, wherein the extension portion includes a plurality of radially outward protruded sections spaced along a peripheral edge of the second portion, such that a recess is formed between any two adjacent ones of the outward protruded sections of the extension portion.

7. The fan device as claimed in claim 4, wherein the base includes a bearing cup portion and a plurality of connecting arm portions; the bearing cup portion being extended from a center of the base toward the first opening, and the connecting arm portions being spaced along an outer peripheral edge of the base to radially extend toward and connect to an inner wall surface of the housing.

8. The fan device as claimed in claim 4, further comprising a shaft having an end connected to an inner top surface of the hub and another opposite end inserted into the bearing cup portion.

9. The fan device as claimed in claim 4, wherein the rotor includes an iron shell and a magnetic ring; the iron shell being attached to an inner wall surface of the hub, and the magnetic ring being mounted to an inner side of the iron shell to face toward the stator.

10. The fan device as claimed in claim 8, wherein the rotor includes an iron shell and a magnetic ring; the iron shell being attached to an inner wall surface of the hub, and the magnetic ring being mounted to an inner side of the iron shell to face toward the stator.
